(19) United States
(12) Patent Application Publication
(10) Pub. No.: US 2005/0041542 A1
(43) Pub. Date: Feb. 24, 2005

(54) Optical display device

(76) Inventors: Kei Kobayashi, Takatsuki-shi (JP); Jun Kikuchi, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/501,360

(22) PCT Filed: Apr. 18, 2003
(86) PCT No.: PCT/JP03/05027

(30) Foreign Application Priority Data
Sep. 30, 2002 (JP) 2002-285028

(51) Int. Cl. G11B 7/00

(52) U.S. Cl. 369/44.28

(57) ABSTRACT

There is provided an optical disc device comprising a step number calculation means (110) for calculating the number of steps of a motor (106) on the basis of the target number of tracks required for traverse seek; a differential number calculation means (112) for calculating the number of differential tracks over which an objective lens should be shifted, on the basis of the target number of tracks and the number of steps; and a tracking jump control means (113) for driving an actuator (104) at track intervals by applying a control signal generated on the basis of the number of differential tracks, to an actuator driving circuit (114). After advancing a traverse (105) by driving the motor by the number of steps calculated by the step number calculation means, tracking-jump is carried out over the differential tracks to shift an objective lens (103).

### TECHNICAL FIELD

The present invention relates to an optical disc device and, more particularly, to an optical disc device that drives a traverse at intervals corresponding to a predetermined number of tracks, in the direction of the radius of an optical disc, thereby accessing to a target track.

### BACKGROUND ART

In recent years, there has been developed optical disc devices for recording or reproducing data in/from an optical disc having spiral tracks, such as a CD (Compact Disk), MD (Mini Disk), DVD (Digital Versatile Disk), and the like. In these optical disc devices, an objective lens is shifted in the direction of the radius of the optical disc to make an access to a target track.

For example, there has been proposed an optical disc device that realizes an accurate access to a target track by shifting an optical pickup which movably holds an objective lens in the direction of the radius of an optical disc, over a predetermined number of tracks. Specifically, this optical disc device continuously reads addresses of tracks on the optical disc for a predetermined period of time immediately after a command for shifting is made, and corrects the count of the number of tracks during shifting by a counter according to the read addresses, thereby to realize an accurate access (for example, refer to Patent Document 1).

Patent Document 1
Japanese Published Patent Application No. Hei. 5-101412

Further, there has been proposed an optical disc device that performs an access to a target track by traverse seek. Hereinafter, a description will be given of the construction and operation of a conventional optical disc device that performs traverse seek, with reference to FIG. 13.

A conventional optical disc device 600 includes a disc motor 102 for rotating an optical disc 101 on which data are recorded in tracks; an objective lens 103 for irradiating the optical disc 101 with a laser beam and receiving a reflected light beam; an actuator 104 for moving the objective lens 103 in the direction of the radius of the optical disc 101; a traverse 105 for holding the objective lens 103 and.the actuator 104 movably in the direction of the radius of the optical disc 101; and a motor 106 for driving the traverse 105 in the direction of the radius of the optical disc 101. Further, the optical disc device 600 includes a tracking error signal generation circuit 107 for calculating an error between the position of a track on the optical disc 101 and the position of the objective lens 103 that is a laser beam irradiation position, on the basis of the reflected light beam received by the objective lens 103, thereby generating a tracking error signal as an error signal; a tracking servo filter 108 for generating a tracking drive output for making the objective lens 103 follow the track on the optical disc 101 (hereinafter referred to as “tracking on”) on the basis of the tracking error signal outputted from the tracking error signal generation circuit 107; an actuator driving circuit 601 for driving the actuator 104 on the basis of the tracking drive output outputted by the tracking servo filter 108; a target number calculation means 109 for calculating the number of tracks up to the target track (hereinafter referred to as “target number of tracks”), on the basis of a target track address AD2 to which an access should be made, and an address of a track where the objective lens 103 is positioned at starting of traverse seek (hereinafter referred to as “current track address AD1); a step number calculation means 110 for calculating the number of steps for shifting the traverse 105 on the basis of the target number of tracks; and a motor driving circuit 111 for driving the motor 106 on the basis of the output of the step number calculation means 110.

FIG. 14 shows the positional relationships among the tracks on the optical disc 101, the objective lens 103, and the traverse 105 during traverse seek.

During traverse seek, the motor 106 shifts the traverse 105 at a predetermined interval L1 or an interval equal to an integral multiple of the predetermined interval L1. The predetermined interval L1 is equal to a track interval D1 or an integral multiple of the track interval D1. Hereinafter, a distance corresponding to the predetermined interval L1 or an integral multiple of the interval L1, which is traveled by the traverse 105 being driven by the motor 106, is referred to as a step.

Next, a description will be given of a method of performing traverse seek by the conventional optical disc device 600 constituted as described above.

FIG. 15 is a flowchart for explaining the method of performing traverse seek by the conventional optical disc device 600.

When traverse seek is started, the target number calculation means 109 calculates the target number of tracks on the basis of the target track address AD2 and the current track address AD1 where the objective lens 103 is positioned at start of traverse seek. Then, the step number calculation means 110 calculates the amount of shift of the traverse 105 for tracking on the target track, and converts the calculated amount of shift into the number of steps of the motor 106. As shown in FIG. 14, when there is a distance equivalent to 43 tracks from the track at which the traverse seek is started to the target track, and the predetermined interval L1 by which the motor 106 shifts the traverse 105 by one step is equivalent to 13 tracks, the number of steps calculated by the step number calculation means 110 is 3 (step S91).

Next, the track-following operation is stopped (tracking off) (step S92). Then, the motor driving circuit 111 drives the motor 106 by the number of steps calculated in step S91, thereby moving the traverse 105. As shown in FIG. 14, the traverse 105 is shifted by 3 steps on the basis of the number of steps calculated by the step number calculation means 110 (step S93). Then, tracking-on is carried out again (step S94) to obtain the address (step S95).

When the obtained address is the target track address AD2, since the objective lens 103 accesses the target track at this time, the traverse seek is ended (step S96). On the other hand, when it is not the target track address AD2, the objective lens 103 is brought closer to the target track by tracking jump, i.e., by shifting~the objective lens 103 at track intervals by the actuator 104. In the example shown in FIG. 14, tracking jump is carried out over four tracks. At this time, the amount of lens shift immediately before the traverse seek due to the track-following operation is incorporated in traverse advancing and compensated (step S97). Then, an address acquisition means (not shown) obtains the address of the track on which the objective lens 103 is tracking on, thereby to complete the processing (step S98).

As described above, since the distance traveled by the traverse 105 by one step of the motor 106 is longer than the track interval D1, the motor 106 cannot drive the traverse 105 at the track interval D1. Therefore, when there is an error between the number of tracks to be achieved in traverse seek (target number of tracks) and the number of tracks over which the traverse 105 is actually shifted by the motor 106, tracking on the target track cannot be carried out by traverse seek.

When tracking on the target track fails, in order to realize an accurate access during traverse seek, tracking-on is carried out to obtain the address after advancing the traverse 105, and the number of tracks from the currently tracking-on track to the target track is calculated to make an access again. This results in an increase in time required for accessing the target track.

The present invention is made to solve the above-described problems and has for its object to provide an optical disc device that reduces access time during traverse seek, and performs accurate access to the target track.

### DISCLOSURE OF THE INVENTION

In order to solve the above-mentioned problems, an optical disc device according to claim 1 of the present invention comprises: an actuator for moving an objective lens that irradiates an optical disc with a laser beam; a traverse for holding the objective lens and the actuator so that the objective lens and the actuator are mutually movable; a motor for performing step driving to advance the traverse for every unit travel distance; an actuator driving means for driving the actuator on the basis of an error between the position of a track on the optical disc and the position to which the objective lens applies the laser beam, thereby to make the objective lens follow the track on the optical disc; and a motor driving means for calculating the number of steps on the basis of the number of tracks from the position of the objective lens up to a target track to be accessed, and driving the traverse by the calculated number of steps; wherein the actuator driving means calculates the number of tracks from the position of the objective lens up to the target track to be accessed, and driving the actuator so as to shift the objective lens up to the target track on the basis of the calculated number of tracks.

According to claim 2 of the present invention, the optical disc device according to claim 1 further comprises a target number calculation means for calculating the number of tracks up to the target track on the basis of a current address where the objective lens is currently positioned, and the target track address; the motor drives the traverse by a predetermined number of tracks as one step of unit travel distance; the motor driving circuit calculates the number of steps for driving the traverse by the motor, on the basis of the target number of tracks that is calculated by the target number calculation means, and the unit travel distance of the motor, and drives the traverse by the calculated number of steps; and the actuator driving means calculates the number of tracks from the position of the objective lens up to the target track after advancing the traverse by the motor, and drives the actuator at track intervals so as to shift the objective lens by the calculated number of tracks.

According to claim 3 of the present invention, the optical disc device as defined in claim 1 further comprises a target number calculation means for calculating the number of tracks up to the target track on the basis of a current address where the objective lens is currently positioned, and the target track address; the motor drives the traverse by a predetermined number of tracks as one step of unit travel distance; the motor driving circuit calculates the number of steps for driving the traverse by the motor, on the basis of the target number of tracks that is calculated by the target number calculation means, and the unit travel distance of the motor, and drives the traverse by the calculated number of steps; and the actuator driving means calculates the distance from the position of the objective lens after advancing the traverse by the motor, up to the target track, and drives the actuator so as to shift the objective lens by the calculated distance.

According to claim 4 of the present invention, an optical disc device comprises: an actuator for moving an objective lens that irradiates an optical disc with a laser beam; a traverse for holding the objective lens and the actuator so that the objective lens and the actuator are mutually movable; a motor for performing step driving to advance the traverse for every unit travel distance; an actuator driving means for generating a first tracking drive signal on the basis of an error between the position of a track on the optical disc and the position to which the objective lens applies the laser beam, and applying the first tracking drive signal to the actuator to make the objective lens follow the track on the optical disc; a ratio calculation means for shifting the objective lens at track intervals over a predetermined number of tracks to obtain the amount of shift of the objective lens and the first tracking drive signal at this time, and calculating the ratio of the amount of shift of the objective lens to the first tracking drive signal; a target number calculation means for calculating the number of tracks up to the target track on the basis of a current address where the objective lens is currently positioned, and a target track address to be accessed; and a motor driving means for calculating the number of steps for advancing the traverse by the motor, on the basis of the target number of tracks calculated by the target number calculation means and the unit travel distance of the motor, and driving the motor by the calculated number of steps; wherein the actuator driving means calculates the distance from the position of the objective lens after advancing the traverse by the motor, up to the target track, generates a second tracking drive signal on the basis of the calculated distance and the ratio, and drives the actuator to shift the objective lens up to the target track.

According to claim 5 of the present invention, in the optical disc device according to claim 4, the ratio calculation means calculates the ratio of the amount of shift of the objective lens, which amount of shift is obtained when rotating the optical disc with the traverse being fixed and the objective lens following the track, to the first tracking drive signal.

According to claim 6 of the present invention, in the optical disc device according to claim 4, the ratio calculation means calculates the ratio of the amount of shift of the objective lens, which amount of shift is obtained when advancing the traverse by a predetermined distance with the objective lens being held, to the first tracking drive signal.

As described above, the optical disc device according to claim 1 of the present invention comprises: an actuator for moving an objective lens that irradiates an optical disc with a laser beam; a traverse for holding the objective lens and the actuator so that the objective lens and the actuator are mutually movable; a motor for performing step driving to advance the traverse for every unit travel distance; an actuator driving means for driving the actuator on the basis of an error between the position of a track on the optical disc and the position to which the objective lens applies the laser beam, thereby to make the objective lens follow the track on the optical disc; and a motor driving means for calculating the number of steps on the basis of the number of tracks from the position of the objective lens up to a target track to be accessed, and driving the traverse by the calculated number of steps; wherein the actuator driving means calculates the number of tracks from the position of the objective lens up to the target track to be accessed, and driving the actuator so as to shift the objective lens up to the target track on the basis of the calculated number of tracks. Therefore, it is possible to compensate a difference between the number of tracks up to the target track and the number of tracks over which the motor advances the traverse, thereby enhancing the access precision. Further, it is possible to access the target track without obtaining the address where the objective lens is positioned in the middle of the access, thereby reducing the access time up to the target track.

Furthermore, according to claim 2 of the present invention, the optical disc device according to claim 1 further comprises a target number calculation means for calculating the number of tracks up to the target track on the basis of a current address where the objective lens is currently positioned, and the target track address; the motor drives the traverse by a predetermined number of tracks as one step of unit travel distance; the motor driving circuit calculates the number of steps for driving the traverse by the motor, on the basis of the target number of tracks that is calculated by the target number calculation means, and the unit travel distance of the motor, and drives the traverse by the calculated number of steps; and the actuator driving means calculates the number of tracks from the position of the objective lens up to the target track after advancing the traverse by the motor, and drives the actuator at track intervals so as to shift the objective lens by the calculated number of tracks. Therefore, it is possible to compensate a difference between the number of tracks up to the target track and the number of tracks over which the motor advances the traverse, thereby enhancing the access precision. Further, it is possible to access the target track without obtaining the address where the objective lens is positioned in the middle of the access, thereby reducing the access time up to the target track.

Furthermore, according to claim 3 of the present invention, the optical disc device as defined in claim 1 further comprises a target number calculation means for calculating the number of tracks up to the target track on the basis of a current address where the objective lens is currently positioned, and the target track address; the motor drives the traverse by a predetermined number of tracks as one step of unit travel distance; the motor driving circuit calculates the number of steps for driving the traverse by the motor, on the basis of the target number of tracks that is calculated by the target number calculation means, and the unit travel distance of the motor, and drives the traverse by the calculated number of steps; and the actuator driving means calculates the distance from the position of the objective lens after advancing the traverse by the motor, up to the target track, and drives the actuator so as to shift the objective lens by the calculated distance. Therefore, it is possible to compensate a difference between the number of tracks up to the target track and the number of tracks over which the motor advances the traverse, thereby enhancing the access precision. Further, it is possible to access the target track without obtaining the address where the objective lens is positioned in the middle of the access, thereby reducing the access time up to the target track.

Furthermore, according to claim 4 of the present invention, an optical disc device comprises: an actuator for moving an objective lens that irradiates an optical disc with a laser beam; a traverse for holding the objective lens and the actuator so that the objective lens and the actuator are mutually movable; a motor for performing step driving to advance the traverse for every unit travel distance; an actuator driving means for generating a first tracking drive signal on the basis of an error between the position of a track on the optical disc and the position to which the objective lens applies the laser beam, and applying the first tracking drive signal to the actuator to make the objective lens follow the track on the optical disc; a ratio calculation means for shifting the objective lens at track intervals over a predetermined number of tracks to obtain the amount of shift of the objective lens and the first tracking drive signal at this time, and calculating the ratio of the amount of shift of the objective lens to the first tracking drive signal; a target number calculation means for calculating the number of tracks up to the target track on the basis of a current address where the objective lens is currently positioned, and a target track address to be accessed; and a motor driving means for calculating the number of steps for advancing the traverse by the motor, on the basis of the target number of tracks calculated by the target number calculation means and the unit travel distance of the motor, and driving the motor by the calculated number of steps; wherein the actuator driving means calculates the distance from the position of the objective lens after advancing the traverse by the motor, up to the target track, generates a second tracking drive signal on the basis of the calculated distance and the ratio, and drives the actuator to shift the objective lens up to the target track. Therefore, the ratio between the amount of shift of the objective lens, which is obtained when shifting the objective lens at track intervals by a predetermined number of tracks, and the first tracking drive signal obtained at this time can be calculated in advance of performing access, whereby the second tracking drive output can be accurately generated using the calculated ratio, on the basis of the distance from the position of the objective lens after advancing the traverse by the motor to the target track, when performing access, resulting in enhanced access precision. Further, even when the optical disc is replaced or the environment where the optical disc device is placed is changed, the second tracking drive output can be calculated using the ratio adaptive to each optical disc or the current environment, whereby the target track can be accessed with high accuracy.

Furthermore, according to claim 5 of the present invention, in the optical disc device according to claim 4, the ratio calculation means calculates the ratio of the amount of shift of the objective lens, which amount of shift is obtained when rotating the optical disc with the traverse being fixed and the objective lens following the track, to the first tracking drive signal. Therefore, the above-described ratio can be calculated in advance of performing access, whereby the second tracking drive output can be accurately generated using the ratio, on the basis of the distance from the position of the objective lens after advancing the traverse by the motor to the target track, when performing access, resulting in enhanced access precision. Further, even when the optical disc is replaced or the environment where the optical disc device is placed is changed, the second tracking drive output can be calculated using the ratio adaptive to each optical disc or the current environment, whereby the target track can be accessed with high accuracy.

Furthermore, according to claim 6 of the present invention, in the optical disc device according to claim 4, the ratio calculation means calculates the ratio of the amount of shift of the objective lens, which amount of shift is obtained when advancing the traverse by a predetermined distance with the objective lens being held, to the first tracking drive signal. Therefore, the above-described ratio can be calculated in advance of performing access, whereby the second tracking drive output can be accurately generated using the ratio, on the basis of the distance from the position of the objective lens after advancing the traverse by the motor to the target track, when performing access, resulting in enhanced access precision. Further, even when the optical disc is replaced or the environment where the optical disc device is placed is changed, the second tracking drive output can be calculated using the ratio adaptive to each optical disc or the current environment, whereby the target track can be accessed with high accuracy.

### BRIEF DESCRIPTION OF THE DRAWINGS

FIG. 1 is a block diagram illustrating the construction of an optical disc device according to a first embodiment of the present invention.

FIG. 2 is a diagram illustrating the positional relationships among tracks on an optical disc, an objective lens, and a traverse during traverse seek, in the optical disc device according to the first embodiment of the present invention.

FIG. 3 is a flowchart for explaining a method of performing traverse seek by the optical disc device according to the first embodiment of the present invention.

FIG. 4 is a block diagram illustrating the construction of an optical disc device according to a second embodiment of the present invention.

FIG. 5 is a diagram illustrating the positional relationships among tracks on an optical disc, an objective lens, and a traverse during traverse seek, in the optical disc device according to the second embodiment of the present invention.

FIG. 6 is a flowchart for explaining a method of performing traverse seek by the optical disc device according to the second embodiment of the present invention.

FIG. 7 is a block diagram illustrating the construction of an optical disc device according to a third embodiment of the present invention.

FIG. 8(a) is a flowchart for explaining a method of calculating the ratio of an amount of shift of the objective lens to a tracking drive output by the optical disc device according to the third embodiment of the present invention, and FIG. 8(b) is a flowchart for explaining a method of performing traverse seek.

FIG. 9 is a block diagram illustrating the construction of an optical disc device according to a fourth embodiment of the present invention.

FIG. 10(a) is a flowchart for explaining a method of calculating the ratio of an amount of shift of the objective lens to a tracking drive output by the optical disc device according to the fourth embodiment of the present invention, and FIG. 10(b) is a flowchart for explaining a method of performing traverse seek.

FIG. 11 is a block diagram illustrating the construction of an optical disc device according to a fifth embodiment of the present invention.

FIG. 12(a) is a flowchart for explaining a method of calculating the ratio of an amount of shift of the objective lens to a tracking drive output by the optical disc device according to the fifth embodiment of the present invention, and FIG. 12(b) is a flowchart for explaining a method of performing traverse seek.

FIG. 13 is a block diagram illustrating the construction of the conventional optical disc device.

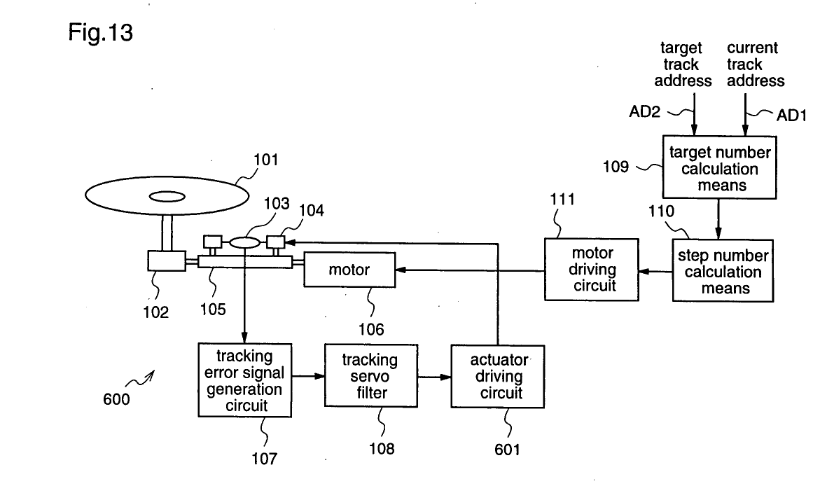

FIG. 14 is a diagram illustrating the positional relationships among tracks on an optical disc, an objective lens, and a traverse during traverse seek, in the conventional optical disc device.

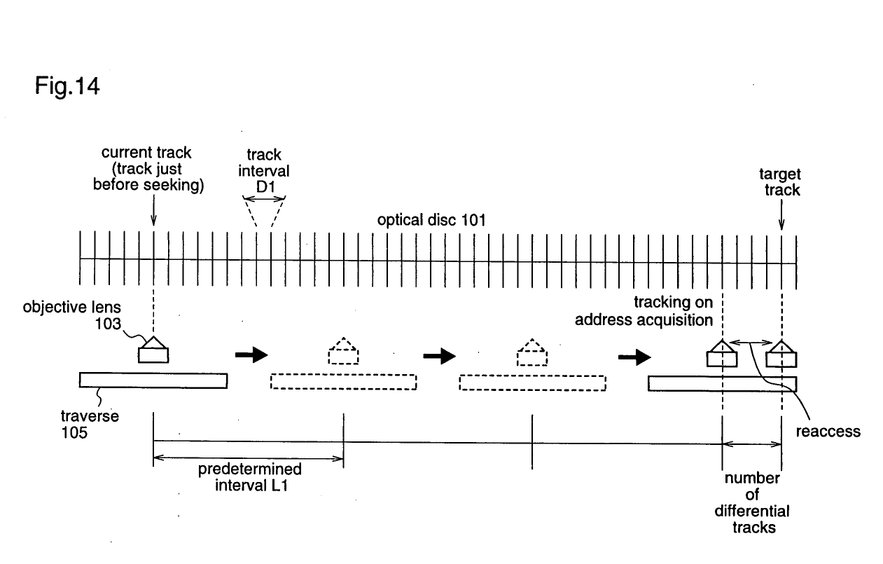

FIG. 15 is a flowchart for explaining a method of performing traverse seek by the conventional optical disc device.

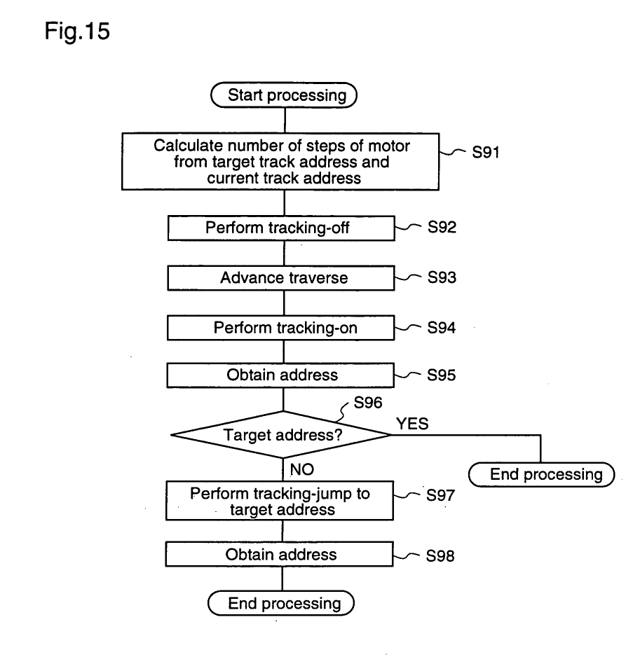

### BEST MODE TO EXECUTE THE INVENTION

(Embodiment 1)

An optical disc device according to a first embodiment of the present invention will be described with reference to the drawings.

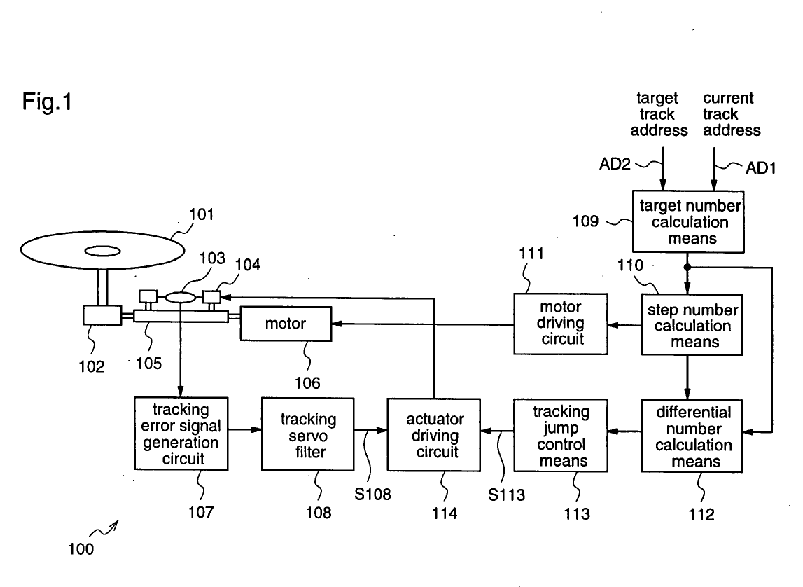

FIG. 1 is a block diagram illustrating the construction of an optical disc device 100 according to the first embodiment of the present invention.

The optical disc device 100 according to the first embodiment includes a disc motor 102 for rotating an optical disc 101 on which data are recorded in tracks; an objective lens 103 for irradiating the optical disc 101 with a laser beam and receiving a reflected light beam; an actuator 104 for moving the objective lens 103 in the direction of the radius of the optical disc 101; a traverse 105 for holding the objective lens 103 and the actuator 104 movably in the direction of the radius of the optical disc 101; and a motor 106 for driving the traverse 105 in the direction of the radius of the optical disc 101. Further, the optical disc device 100 includes a tracking error signal generation circuit 107 for calculating an error between the position of a track on the optical disc 101 and the position of the objective lens 103 (laser beam irradiation position) on the basis of the reflected light beam that is received by the objective lens 103, thereby generating a tracking error signal as an error signal; a tracking servo filter 108 for generating a tracking drive output S108 for making the objective lens 103 follow the track on the optical disc 101 (hereinafter referred to as “tracking-on”) on the basis of the tracking error signal outputted from the tracking error signal generation circuit 107; a target number calculation means 109 for calculating the number of tracks up to a target track (hereinafter referred to as “target number of tracks”) on the basis of a track address where the objective lens 103 is positioned at start of traverse seek (hereinafter referred to as “current track address AD1”) and a target track address AD2 to be accessed; a step number calculation means 110 for calculating the number of steps by which the traverse 105 should be shifted, on the basis of the target number of tracks; a motor driving circuit 111 for driving the motor 106 on the basis of the output of the step number calculation means 110; a differential number calculation means 112 for calculating the number of tracks up to the target track from the track on which the objective lens 103 is positioned (hereinafter referred to as “number of differential tracks”) when driving the motor 106 by the calculated number of steps; a tracking jump control means 113 for generating a control signal S113 on the basis of the calculated number of differential tracks and applying the control signal S113 to an actuator driving circuit 114, thereby driving the actuator 104 at track intervals; and an actuator driving circuit 114 for driving the actuator 104 on the basis of the tracking drive output S108 supplied from the tracking servo filter 108 or the control signal S113 supplied from the tracking jump control means 113.

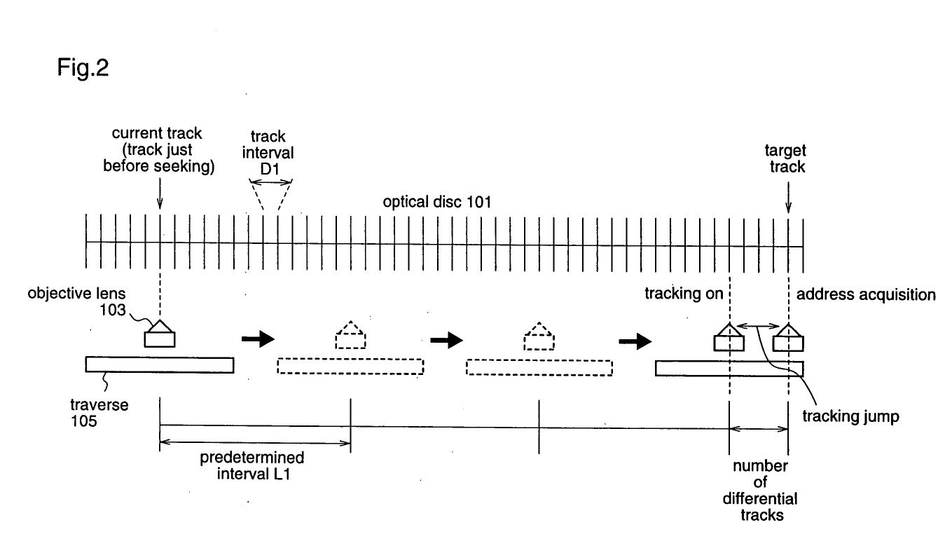

FIG. 2 shows the positional relationships among the tracks on the optical disc 101, the objective lens 103, and the traverse 105 during traverse seek.

When a power is applied, the actuator 104 shifts the objective lens 103 by a distance according to the power. When a pulse is applied, the actuator 104 shifts the objective lens 103 by the number of pulses that are supplied at track interval D1, that is, makes the objective lens 103 perform tracking jump.

When the pulse is applied, the motor 106 shifts the traverse 105 by the number of supplied pulses at predetermined interval L1 or integral multiple mL1 of the predetermined interval L1. The predetermined interval L1 is equal to track interval D1 or integral multiple nD1 of the track interval D1. Hereinafter, the predetermined interval L1 or mL1 that is a unit interval by which the motor 106 shifts the traverse 105 is referred to as a step. Further, the motor 106 may be a stepping motor that shifts the traverse 105 at step intervals.

The number of steps calculated by the step number calculation means 110 is input to the motor driving circuit 111. Then, the motor driving circuit 111 outputs pulses as many as the number of steps to the motor 106, thereby to drive the motor 106 by the number of steps.

The differential number calculation means 112 calculates the number of differential tracks over which the objective lens 103 should be shifted, on the basis of the target number of tracks and the number of steps. The number of differential tracks may be the remainder obtained when dividing the target number of tracks by the number of tracks corresponding to one step.

The actuator driving circuit 114 is supplied with either the tracking drive output S108 indicating the amount of shift of the objective lens 103 or the control signal S113 generated by the tracking jump control means 113 on the basis of the number of differential tracks. When the tracking drive output S108 is input to the actuator driving circuit 114, the actuator driving circuit 114 outputs a power according to the magnitude of the tracking drive output S108 to the actuator 104, thereby to shift the objective lens 103. On the other hand, when the control signal S113 is input to the actuator driving circuit 114, the actuator driving circuit 114 outputs pulses as many as the number of differential tracks to the actuator 104, thereby making the objective lens 103 perform tracking jump over tracks as many as the number of differential tracks.

Next, a method of performing traverse seek in the optical disc device 100 constructed as described above will be described with reference to the drawings.

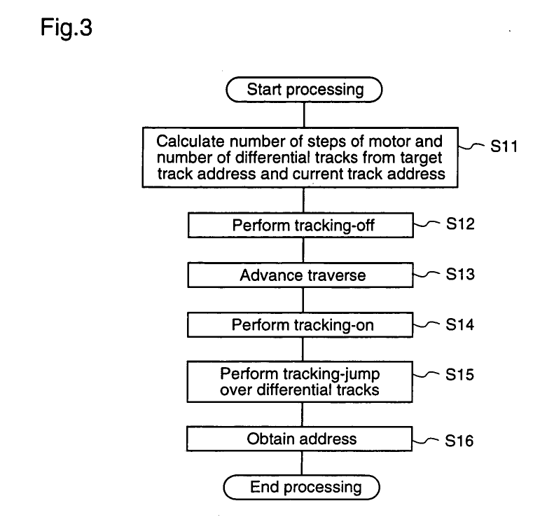

FIG. 3 is a flowchart for explaining the traverse seek method to be performed by the optical disc device 100.

When traverse seek is started, an address acquisition means (not shown) obtains the current track address AD1 where the objective lens 103 is positioned currently. Then, the target number calculation means 109 calculates the target number of tracks on the basis of the target track address AD2 and the current track address AD1. The step number calculation means 110 calculates the amount of shift of the traverse 105 which is required for tracking on the target track, on the basis of the calculated target number of tracks, and converts the calculated amount of shift into the number of steps of the motor 106. Further, the differential number calculation means 112 calculates the number of differential tracks on the basis of the target number of tracks and the number of steps. As shown in FIG. 2, when the number of tracks from the track at which traverse seek is started up to the target track is 43 and the predetermined interval L1 over which the motor 106 shifts the traverse 105 by one step is equivalent to 13 tracks, the number of steps calculated by the step number calculation means 110 is 3, and the number of differential tracks calculated by the differential number calculation means 112 is 4 (step S11).

Next, the track-following operation is stopped, i.e., tracking-off is carried out (step S12). Then, the motor driving circuit 111 drives the motor 106 by the number of steps calculated in step S11 to shift the traverse 105. FIG. 2 shows the state where the traverse 105 is shifted by 3 steps on the basis of the number of steps calculated by the step number calculation means 110 (step S13). Then, tracking-on is carried out again (step S14).

Since tracking jump can be carried out when the objective lens 103 achieves tracking-on, the actuator driving circuit 114 drives the actuator 104 by the number of differential tracks on the basis of the control signal S113 outputted from the tracking jump control means 113 to shift the objective lens 103. FIG. 2 shows the state where the objective lens 103 performs tracking jump by 4 tracks on the basis of the number of differential tracks calculated by the differential number calculation means 112 (step S15). Since, at this time, the objective lens 103 is tracking on the target track, the address acquisition means obtains the address of the track to complete the traverse seek (step S16).

The optical disc device 100 according to the first embodiment is provided with the step number calculation means 110 for calculating the number of steps of the motor 106 on the basis of the target number of tracks for traverse seek; the differential number calculation means 112 for calculating the number of differential tracks over which the objective lens 103 should be shifted, on the basis of the target number of tracks and the number of steps; and the tracking jump control means 113 for driving the actuator 104 at track intervals by supplying the actuator driving circuit 114 with the control signal S113 that is generated on the basis of the number of differential tracks; and the motor 106 is driven by the number of steps calculated by the step number calculation means 110 to shift the traverse 105, and thereafter, tracking jump is carried out by the number of differential tracks to shift the objective lens 103, whereby accurate access can be carried out by traverse seek.

Furthermore, the step of once obtaining the address after advancing the traverse 105 and the step of calculating the number of tracks up to the target track address AD2, which steps are required for the conventional optical disc device 600, are dispensed with, resulting in a reduction in access time to the target track.

[Embodiment 2]

An optical disc device according to a second embodiment of the present invention will be described with reference to the drawings.

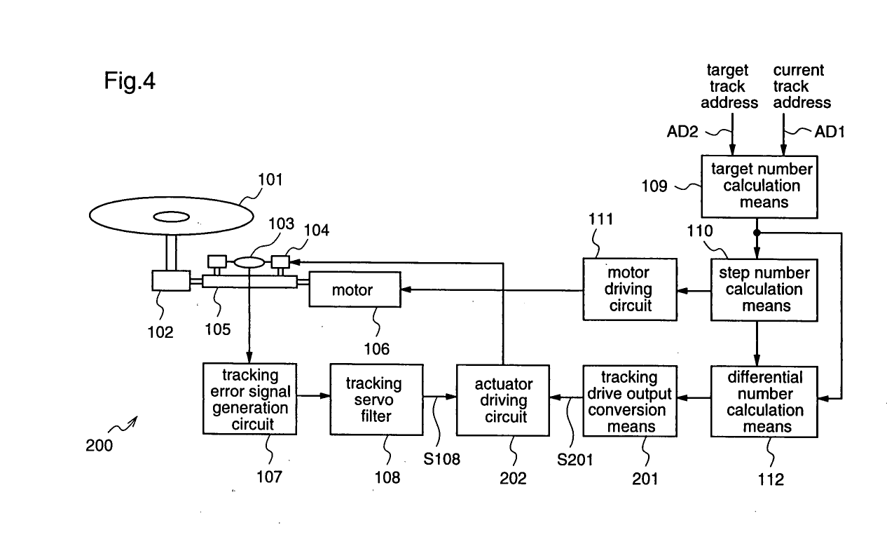

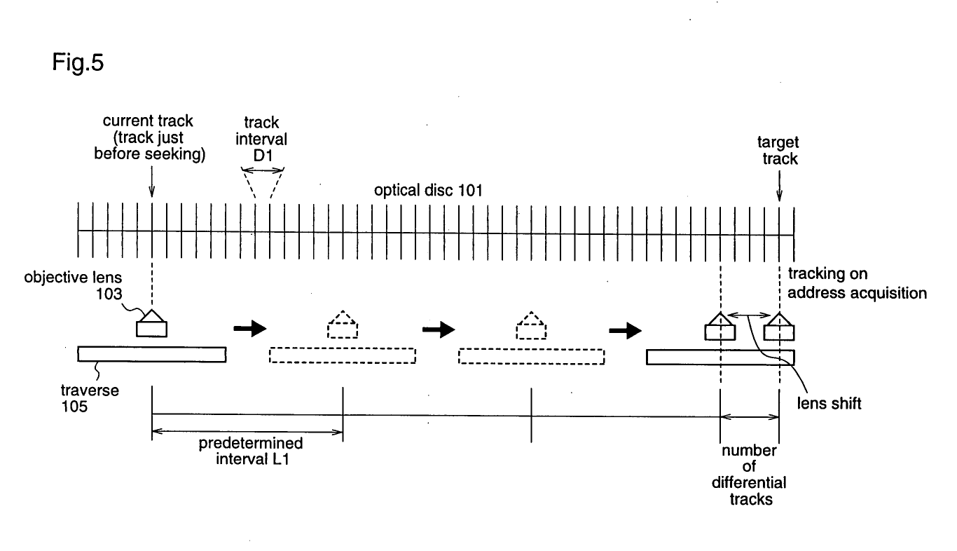

FIG. 4 is a block diagram illustrating the construction of an optical disc device 200 according to the second embodiment of the present invention. FIG. 5 is a diagram illustrating the positional relationships among tracks on the optical disc 101, the objective lens 103, and the traverse 105 during traverse seek. In FIG. 4, the same reference numerals as those shown in FIG. 1 denote the same or corresponding parts.

In FIG. 4, reference numeral 201 denotes a tracking drive output conversion means for calculating the amount of shift of the objective lens 103 for accessing a target track, on the basis of the number of differential tracks calculated by the differential number calculation means 112, and converting the calculated amount of shift into a tracking drive output S201, and reference numeral 202 denotes an actuator driving circuit for driving the actuator 104 on the basis of a tracking drive output S108 outputted from the tracking servo filter 108 or a tracking drive output S201 outputted from the tracking drive output conversion means 201.

The tracking drive output conversion means 201 controls shifting of the objective lens 103 by the actuator 104 during traverse seek. That is, the tracking drive output conversion means 201 calculates the amount of shift that is required for shifting the objective lens 103 by the number of differential tracks, and outputs a tracking drive output S201 that is generated on the basis of the calculated value, to the actuator driving circuit 114.

The actuator driving circuit 202 receives either the tracking drive output S108 indicating the amount of shift of the objective lens 103 or the tracking drive output S201 that is generated on the basis of the number of differential tracks by the tracking drive output conversion means 201. The actuator driving circuit 202 applies a voltage according to the magnitude of the tracking drive output S108 or S201 to the actuator 104, thereby to shift the objective lens 103.

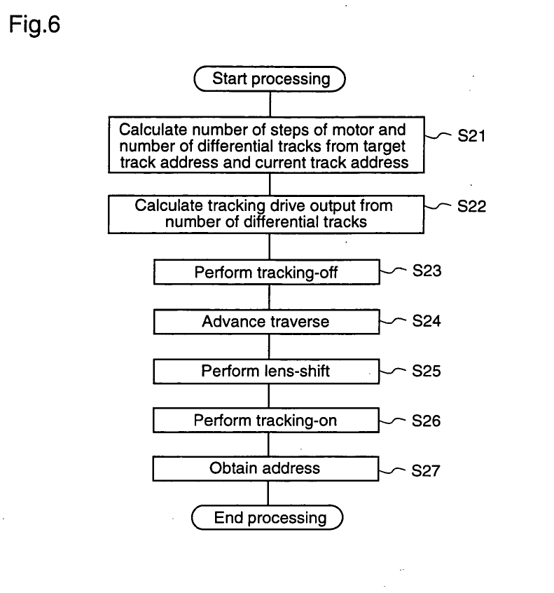

Next, a description will be given of a method for performing traverse seek in the optical disc device 200 thus constructed with reference to FIG. 6.

FIG. 6 is a flowchart for explaining the traverse seek method by the optical disc device 200.

When traverse seek is started and a current track address AD1 is obtained, the target number calculation means 109 calculates the target number of tracks on the basis of the target track address AD2 and the current track address AD1, and the step number calculation means 110 calculates the number of steps of the motor required for tracking on the target track, on the basis of the calculated target number of tracks, and furthermore, the difference numeral calculation means 112 calculates the number of differential tracks on the basis of the target number of tracks and the number of steps (step S21). Then, the tracking drive output conversion means 201 calculates the amount of shift of the objective lens on the basis of the number of differential tracks, generates a tracking drive output S201 on the basis of the calculated value, and applies the tracking drive output S201 to the actuator driving circuit 202 (step S22).

Thereafter, the track-following operation is stopped, i.e., tracking is turned off (step S23), and the motor driving circuit 111 drives the motor 106 by the number of steps calculated in step S21, thereby advancing the traverse (step S24). Thereafter, the actuator driving circuit 202 drives the actuator 104 by the number of differential tracks on the basis of the tracking drive output S201 from the tracking drive output conversion means 201, thereby shifting the lens (step S25).

In this way, tracking-on is carried out (step S26). At this time, since the objective lens 103 is tracking on the target track, the address acquisition means obtains the address of the track to complete the traverse seek (step S27).

In the optical disc device 200 according to the second embodiment, the amount of shift required for shifting the objective lens 103 by the number of differential tracks is calculated on the basis of the target number of tracks for traverse seek and the number of steps of the motor 106, and the tracking drive output S201 generated on the basis of the calculated value is applied to the actuator driving circuit 202. Moreover, after advancing the traverse 105 by the motor 106, the actuator driving circuit 202 drives the actuator 104 on the basis of the tracking drive output S201 from the tracking drive output conversion means 201 to shift the objective lens 103, resulting in accurate access by traverse seek.

(Embodiment 3)

An optical disc device according to a third embodiment of the present invention will be described with reference to the drawings.

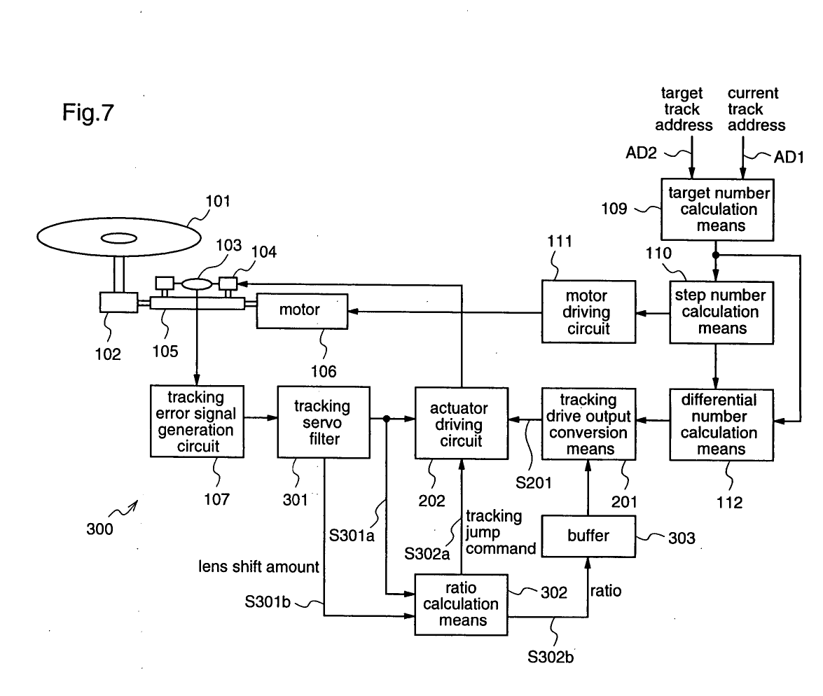

FIG. 7 is a block diagram illustrating the construction of an optical disc device 300 according to a third embodiment of the present invention. In FIG. 7, the same reference numerals as those shown in FIG. 4 denote the same or corresponding parts and, therefore, repeated description is not necessary.

In FIG. 7, 301 denotes a tracking servo filter that outputs a tracking drive output S301a and a lens shift amount S301b indicating the amount of shift of the objective lens 103; 302 denotes a ratio calculation means for calculating the ratio between the amount of shift of the objective lens 103 and the tracking drive output S301a, and stores the calculated ratio S302b into a buffer 303.

Next, the operation of the optical disc device 300 constructed as described above will be described with reference to the drawings.

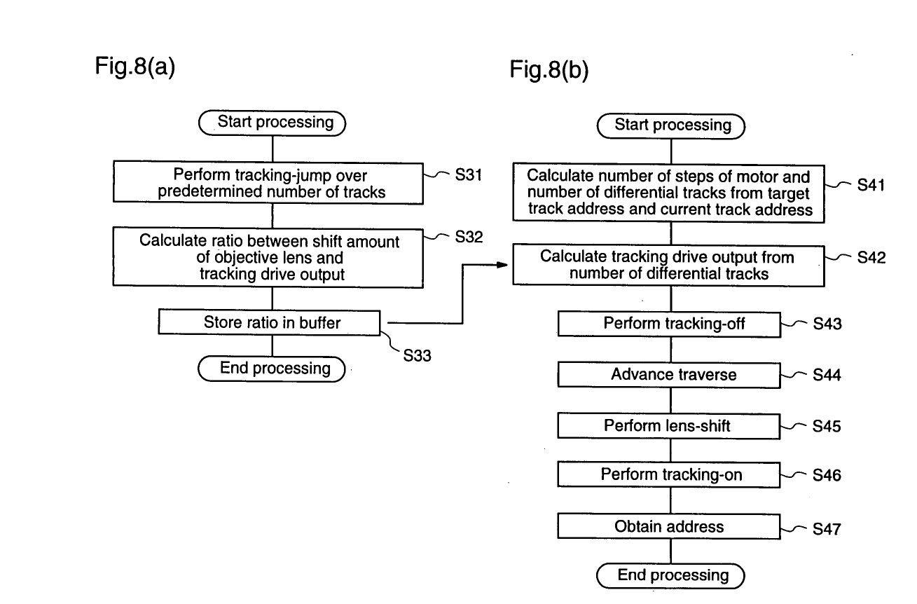

FIG. 8(a) is a flowchart for explaining a method of calculating the ratio between the amount of shift of the objective lens 103 and the tracking drive output S301a, and FIG. 8(b) is a flowchart for explaining a method of performing traverse seek.

In the optical disc device 300 according to the third embodiment, before starting traverse seek, that is, immediately after power-on or immediately after loading of the optical disc 101, the ratio between the amount of shift of the objective lens 103 and the tracking drive output S301a is calculated. Initially, a method for calculating the ratio between the amount of shift of the objective lens 103 and the tracking drive output S301a will be described.

The ratio calculation means 302 outputs a tracking jump command S302a for performing tracking jump over a predetermined number of tracks, to the actuator driving circuit 202. Then, the actuator 104 is driven with the traverse 105 being fixed, whereby tracking jump is carried out over the predetermined number of tracks. At this time, the tracking error signal generation circuit 107 generates a tracking error signal that is an error signal between the position of the track on the optical disc and the position to which the laser beam is applied by the objective lens 103, and the tracking servo filter 301 outputs a lens shift amount S301b indicating the amount of shift of the objective lens 103 and a tracking drive output S301a (step S31). Then, the ratio calculation means 302 calculates the ratio between the tracking drive output S301a and the lens shift amount S301b, which are output from the tracking servo filter 301 when performing tracking jump by the predetermined number of tracks (step S32). The buffer 303 holds the ratio S302b supplied from the ratio calculation means 302 (step S33).

After the ratio S302b between the amount of shift of the objective lens 103 and the tracking drive output S301a is stored in the buffer 303, the optical disc device 300 goes into the state where traverse seek is executable.

Next, a method of performing traverse seek will be described.

When traverse seek is started, the target number calculation means 109 calculates the target number of tracks for traverse seek on the basis of the target track address AD2 and the current track address AD1, the step number calculation means 110 calculates the number of steps of the motor 106 for tracking on the target track, on the basis of the calculated target number of tracks, and the differential number calculation means 112 calculates the number of differential tracks on the basis of the target number of tracks and the number of steps (step S41). Then, the tracking drive output conversion means 201 calculates the value by performing the processes of steps S31 and S32 as described above, and generates a tracking drive output S201 using the ratio S302b that is stored in the buffer 303 in step S33, and using the number of differential tracks that is calculated by the differential number calculation means 112 (step S42).

Thereafter, the track-following operation is stopped, i.e., tracking is turned off (step S43), and the motor driving circuit 111 drives the motor 106 by the number of steps calculated in step S41, thereby advancing the traverse (step S44). Thereafter, the actuator driving circuit 202 drives the actuator 104 on the basis of the tracking drive output S201 generated in step S42, thereby performing lens shift (step S45).

Thereby, tracking-on is carried out (step S46). At this time, since the objective lens 103 is tracking on the target track, the address acquisition means obtains the address of the track to complete the traverse seek processing (step S47).

In the optical disc device 300 according to the third embodiment, before performing traverse seek, the ratio of the amount of shift of the objective lens 103 (lens shift amount S301b) that is obtained by performing tracking jump over a predetermined number of tracks, to the tracking drive output S301a at that time, is calculated, and the ratio S302b as the calculated value is stored. Therefore, during traverse seek, the tracking drive output can be accurately generated from the number of differential tracks by using the stored ratio S302, whereby access precision of traverse seek can be improved. Further, even when the optical disc 101 is replaced or the environment where the optical disc device is placed is changed, the tracking drive output can be calculated according to each optical disc or the current environment.

(Embodiment 4)

An optical disc device according to a fourth embodiment of the present invention will be described with reference to the drawings.

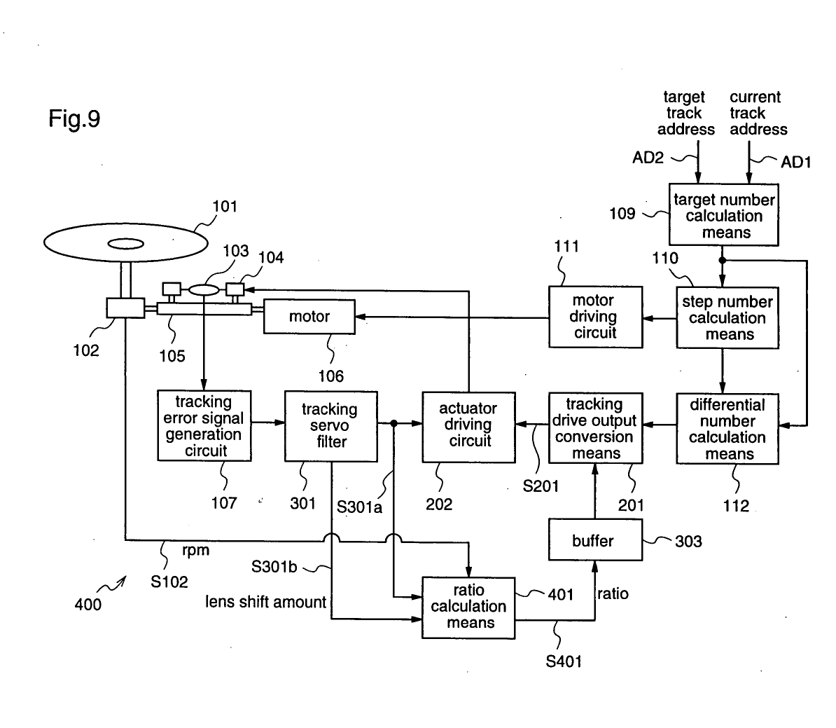

FIG. 9 is a block diagram illustrating the construction of an optical disc device 400 according to the fourth embodiment of the present invention. In FIG. 9, the same reference numerals as those shown in FIG. 7 denote the same or corresponding parts, and therefore, repeated description is not necessary.

In FIG. 9, 401 denotes a ratio calculation means for calculating the ratio between the tracking drive output S301a and the objective lens 103 on the basis of an rpm S102 indicating the number of revolutions of the disc motor 102, the tracking drive output S301a outputted from the tracking servo filter 301, and the lens shift amount S301b, and then storing the calculated ratio S401 into the buffer 303.

Next, the operation of the optical disc device 400 constituted as described above will be described with reference to the drawings.

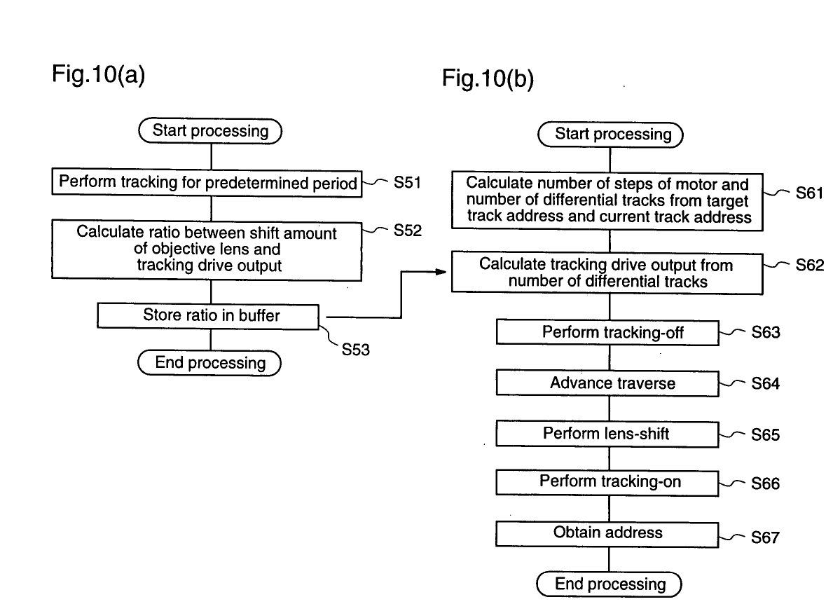

FIG. 10(a) is a flowchart for explaining a method of calculating the ratio between the amount of shift of the objective lens 103 and the tracking drive output S301a by the optical disc device 400, and FIG. 10(b) is a flowchart for explaining the method of performing traverse seek.

The optical disc device 400 according to the fourth embodiment calculates the ratio between the amount of shift of the objective lens 103 and the tracking drive output S301a, before starting traverse seek, that is, immediately after power-on or immediately after loading of the optical disc 101. Initially, the method of calculating the ratio between the amount of shift of the objective lens 103 and the tracking drive output S301a will be described.

First of all, in the optical disc device 400, tracing is carried out for a predetermined period of time. That is, the disc motor 102 is rotated under the state where the objective lens 103 is tracking on and the traverse 105 is fixed. When the optical disc 101 is rotated under the tracking-on state, the objective lens 103 shifts by one track while tracing the track on the optical disc 101, and therefore, the tracking servo filter 301 outputs a tracking drive output S301a for shifting the objective lens 103 by one track, and a lens shift amount S301b indicating the amount of shift of the objective lens 103 for one track. Accordingly, the ratio calculation means 401 obtains, from the rpm 102, the number of tracks traced by the objective lens 103, and also objects the tracking drive output S301a which is outputted from the tracking servo filter 301 when the number of tracks are traced, and the lens shift amount S301b (step S51).

Next, the ratio calculation means 401 calculates the ratio between the tracking drive output S301a and the lens shift amount S301b, which are output from the tracking servo filter 301 when the objective lens 103 traces tracks by the number of tracks obtained from the rpm S102 (step S52). Then, the buffer 303 holds the ratio S401 from the ratio calculation means 401 (step S53).

After storing the ratio S401 of the tracking drive output to the amount of shift of the objective lens 103 into the buffer 303, the optical disc device 400 goes into the state where it can execute traverse seek.

Next, the method of performing traverse seek will be described.

When traverse seek is started, the target number calculation means 109 calculates the target number of tracks for traverse seek on the basis of the target track address AD2 and the current track address AD1, and the step number calculation means 110 calculates the number of steps of the motor 106 required for tracking on the target track, and the differential number calculation means 112 calculates the number of differential tracks on the basis of the target number of tracks and the number of steps (step S61). Then, the tracking drive output conversion means 201 calculates the value by performing the processes of steps S51 and S52, and generates a tracking drive output S201 by using the ratio S401. stored in the buffer 303 in step S53, and the number of differential tracks calculated by the differential number calculation means 112 (step S62).

Thereafter, the track-following operation is stopped, i.e., tracking-off is carried out (step S63), and the motor driving circuit 111 drives the motor 106 by the number of steps calculated in step S61, thereby advancing the traverse (step S64). Thereafter, the actuator driving circuit 202 drives the actuator 104 on the basis of the tracking drive output S201 generated in step S62, thereby performing lens shift (step S65).

Thereby, tracking-on is carried out (step S66). Since, at this time, the objective lens 103 is tracking on the target track, the address acquisition means obtains the address of the track to complete the traverse seek processing (step S67).

In the optical disc device 400 according to the fourth embodiment, before performing traverse seek, the ratio between the amount of shift of the objective lens 103 (lens shift amount S301b) which is obtained by rotating the disc motor 102, and the tracking drive output S301a, under the state where the objective lens 103 is tracking on and the traverse 105 is fixed, and the calculated ratio S401 is stored in the buffer 303. Therefore, when performing traverse seek, the tracking drive output S201 can be accurately generated from the number of differential tracks by using the stored ratio S401, whereby access precision of traverse seek can be improved. Further, even when the optical disc 101 is replaced or the environment where the optical disc device is placed is changed, a tracking drive output S201 adaptive to each optical disc or current environment can be generated.

(Embodiment 5)

An optical disc device according to a fifth embodiment of the present invention will be described with reference to the drawings.

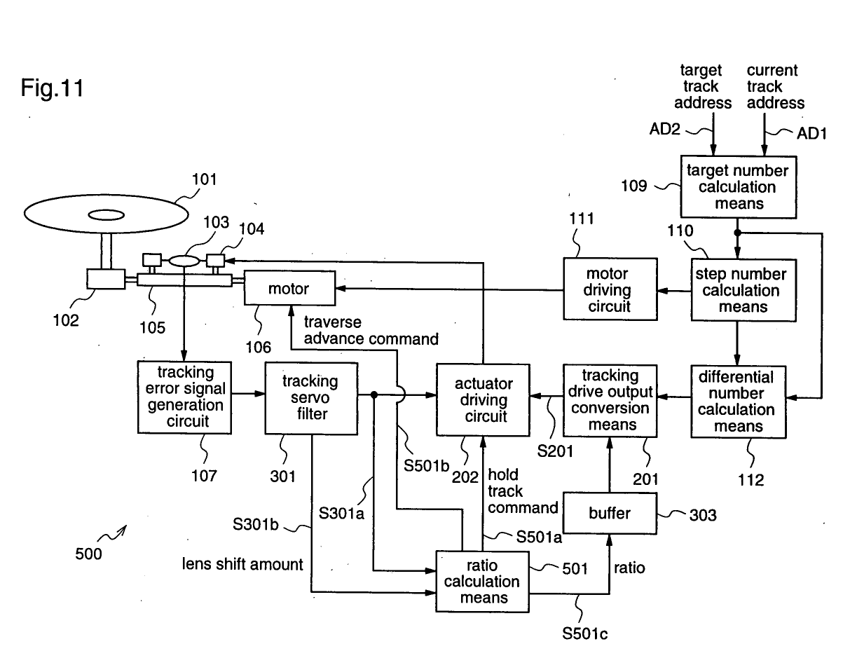

FIG. 11 is a block diagram illustrating the construction of an optical disc device 500 according to the fifth embodiment of the present invention. In FIG. 11, the same reference numerals as those shown in FIG. 9 denote the same or corresponding parts and, therefore, repeated description is not necessary.

In FIG. 11, 501 denotes a ratio calculation means for calculating the ratio between the tracking drive output S301a and the lens shift amount S301b, which are obtained when advancing the traverse for a predetermined distance by the motor 106 under the state where the objective lens 103 is held by fixing the actuator 104, and storing the calculated ratio S501 in the buffer 303.

Next, the operation of the optical disc device 500 thus constructed will be described with reference to the drawings.

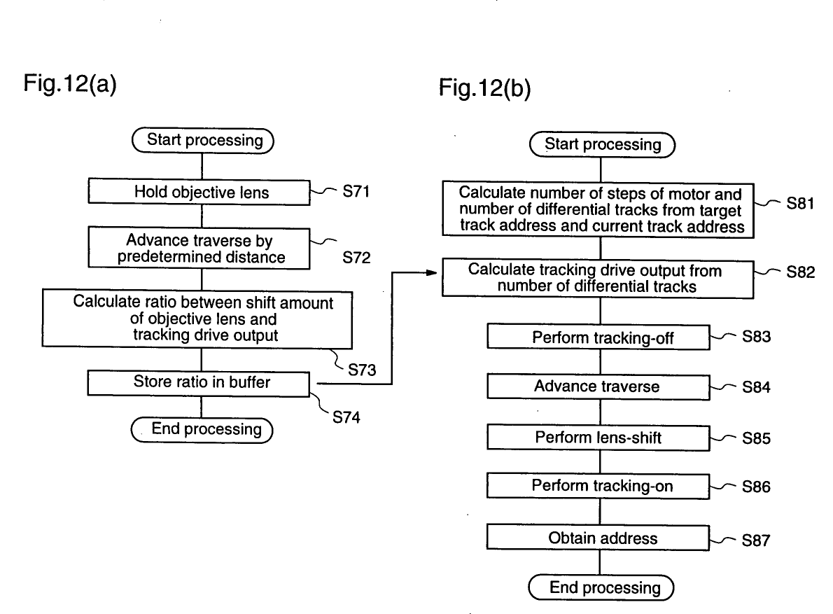

FIG. 12(a) is a flowchart for explaining the method of calculating the ratio between the amount of shift of the objective lens 103 and the tracking drive output S301a, and FIG. 12(b) is a flowchart for explaining the method of performing traverse seek.

The optical disc device 500 according to the fifth embodiment calculates the ratio between the amount of shift of the objective lens 103 and the tracking drive output S301a, before starting traverse seek, that is, immediately after power-on or immediately after loading of the optical disc 101. Initially, the method of calculating the ratio between the amount of shift of the objective lens 103 and the tracking drive output S301a will be described.

When the ratio calculation means 501 outputs a hold track command S501a for holding the objective lens 103 to the actuator driving circuit 202, the actuator driving circuit 202 fixes the actuator 104 to hold the objective lens 103 (step S71). Next, the ratio calculation means 501 outputs a traverse advance command S501b for advancing the traverse 105 by a predetermined distance, to the motor 106, and the motor 106 advances the traverse 105 according to the command S501b. At this time, the tracking servo filter 301 outputs a lens shift amount S301b and a tracking drive output S301a on the basis of a tracking error signal generated by the tracking error signal generation circuit 107 (step S72). Then, the ratio calculation means 501 calculates the ratio between the tracking drive output S301a and the lens shift amount S301b, which are output from the tracking servo filter 301 when advancing the traverse 105 by a predetermined distance with the objective lens 103 being held (step S73). Then, the buffer 303 holds the ratio S501c supplied from the ratio calculation means 501 (step S74).

After the ratio S501c of the tracking drive output to the amount of shift of the objective lens 103 is stored in the buffer 303 in this way, the optical disc device 500 goes into the state where traverse seek is executable.

Next, the method of performing traverse seek will be described.

When traverse seek is started, the target number calculation means 109 calculates the target number of tracks on the basis of the target track address AD2 and the current track address AD1, and the step number calculation means 110 calculates the number of steps of the motor 106 for tracking on the target track, and the differential number calculation means 112 calculates the number of differential tracks on the basis of the target number of tracks and the number of steps (step S81). Then, as described above, the tracking drive output conversion means 201 calculates the value by performing the processes of steps S71 to S73, and generates a tracking drive output S201 on the basis of the ratio S501c stored in the buffer 303 in step S74, and the number of differential tracks calculated by the differential number calculation means 112 (step S82).

Thereafter, the track-following operation is stopped, i.e., tracking-off is carried out (step S83), and the motor drive circuit 111 drives the motor 106 by the number of steps calculated in step S81, thereby advancing the traverse (step S84). Thereafter, the actuator driving circuit 202 drives the actuator 104 on the basis of the tracking drive output S201 generated in step S82, thereby performing lens shift (step S85).

Thereby, tracking-on is carried out (step S86). Since, at this time, the objective lens 103 is tracking on the target track, the address acquisition obtains the address of the track to complete traverse seek processing (step S87).

In the optical disc device 500 according to the fifth embodiment, before performing traverse seek, the ratio of the amount of shift of the objective lens 103 (lens shift amount S301b) that is obtained by advancing the traverse 105 by a predetermined distance with the objective lens 103 being held, to the tracking drive output S301a at this time, and the calculated ratio S501c is stored. Therefore, when performing traverse seek, the tracking drive output S201 can be accurately generated from the number of differential tracks by using the stored ratio S501c, whereby access precision of traverse seek can be improved. Further, even when the optical disc 101 is replaced or the environment where the optical disc device is placed is changed, a tracking drive output S201 adaptive to each optical disc or current environment can be generated.

Applicability in Industry

An optical disc device according to the present invention calculates an amount of shift of a traverse and an amount of shift of an objective lens after shifting the traverse, and drives the traverse and the objective lens on the basis of the calculated values. Therefore, even when performing traverse seek by advancing the traverse at intervals of plural tracks, access to a target track can be made with accuracy in a short time.

1. An optical disc device comprising:
an actuator for moving an objective lens that irradiates an optical disc with a laser beam;
a traverse for holding the objective lens and the actuator so that the objective lens and the actuator are mutually movable;
a motor for performing step driving to advance the traverse for every unit travel distance;
an actuator driving means for driving the actuator on the basis of an error between the position of a track on the optical disc and the position to which the objective lens applies the laser beam, thereby to make the objective lens follow the track on the optical disc; and
a motor driving means for calculating the number of steps on the basis of the number of tracks from the position of the objective lens up to a target track to be accessed, and driving the traverse by the calculated number of steps;
wherein said actuator driving means calculates the number of tracks from the position of the objective lens up to the target track to be accessed, and driving the actuator so as to shift the objective lens up to the target track on the basis of the calculated number of tracks.

2. An optical disc device as defined in claim 1 further comprising:
a target number calculation means for calculating the number of tracks up to the target track on the basis of a current address where the objective lens is currently positioned, and the target track address;
wherein said motor drives the traverse by a predetermined number of tracks as one step of unit travel distance;
said motor driving circuit calculates the number of steps for driving the traverse by the motor, on the basis of the target number of tracks that is calculated by the target number calculation means, and the unit travel distance of the motor, and drives the traverse by the calculated number of steps; and
said actuator driving means calculates the number of tracks from the position of the objective lens up to the target track after advancing the traverse by the motor, and drives the actuator at track intervals so as to shift the objective lens by the calculated number of tracks.

3. An optical disc device as defined in claim 1 further comprising:
a target number calculation means for calculating the number of tracks up to the target track on the basis of a current address where the objective lens is currently positioned, and the target track address;
wherein said motor drives the traverse by a predetermined number of tracks as one step of unit travel distance;
said motor driving circuit calculates the number of steps for driving the traverse by the motor, on the basis of the target number of tracks that is calculated by the target number calculation means, and the unit travel distance of the motor, and drives the traverse by the calculated number of steps; and
said actuator driving means calculates the distance from the position of the objective lens after advancing the traverse by the motor, up to the target track, and drives the actuator so as to shift the objective lens by the calculated distance.

4. An optical disc device comprising:
an actuator for moving an objective lens that irradiates an optical disc with a laser beam;
a traverse for holding the objective lens and the actuator so that the objective lens and the actuator are mutually movable;
a motor for performing step driving to advance the traverse for every unit travel distance;
an actuator driving means for generating a first tracking drive signal on the basis of an error between the position of a track on the optical disc and the position to which the objective lens applies the laser beam, and applying the first tracking drive signal to the actuator to make the objective lens follow the track on the optical disc;
a ratio calculation means for shifting the objective lens at track intervals over a predetermined number of tracks to obtain the amount of shift of the objective lens and the first tracking drive signal at this time, and calculating the ratio of the amount of shift of the objective lens to the first tracking drive signal;
a target number calculation means for calculating the number of tracks up to the target track on the basis of a current address where the objective lens is currently positioned, and a target track address to be accessed; and
a motor driving means for calculating the number of steps for advancing the traverse by the motor, on the basis of the target number of tracks calculated by the target number calculation means and the unit travel distance of the motor, and driving the motor by the calculated number of steps;
wherein said actuator driving means calculates the distance from the position of the objective lens after advancing the traverse by the motor, up to the target track, generates a second tracking drive signal on the basis of the calculated distance and the ratio, and drives the actuator to shift the objective lens up to the target track.

5. An optical disc device as defined in claim 4 wherein said ratio calculation means calculates the ratio of the amount of shift of the objective lens, which amount of shift is obtained when rotating the optical disc with the traverse being fixed and the objective lens following the track, to the first tracking drive signal.

6. An optical disc device as defined in claim 4 wherein said ratio calculation means calculates the ratio of the amount of shift of the objective lens, which amount of shift is obtained when advancing the traverse by a predetermined distance with the objective lens being held, to the first tracking drive signal.
